(19) United States
(12) Patent Application Publication
(10) Pub. No.: US 2004/0128261 A1
(43) Pub. Date: Jul. 1, 2004

(54) Method and system for creating a price forecasting tool

(76) Inventors: Thomas Olavson, San Francisco, CA (US); Greg Jacobus, Campbell, CA (US); Venu Nagali, Cherry Hill, NJ (US); John Penfield Bowman, El Cerrito, CA (US)

Correspondence Address: HEWLETT-PACKARD COMPANY, Intellectual Property Administration, P.O. Box 272400, Fort Collins, CO, 80527-2400, US

(21) Appl. No.: 10/334,391

(22) Filed: Dec. 31, 2002

(51) Int. Cl. G06G 7/00; G06F 17/00

(52) U.S. Cl. 705/400

(57) ABSTRACT

The present invention includes a method and system for creating a price forecasting tool. The method includes receiving historical data related to a commodity, defining a long-run average price trend based on the received historical data and creating a price forecasting tool based on the long-run average price trend wherein the price forecasting tool is capable of taking into account a market momentum of the commodity in order to generate a plurality of scenario prices of the commodity for a plurality of forecast horizons. By utilizing the method and system in accordance with the present invention, a separate statistical model is developed for each forecast horizon, rather than developing a single period model that is then run through simulations to develop longer term forecast distributions.

### FIELD OF THE INVENTION

The present invention relates generally to price modeling and particularly to a method and system for creating a price forecasting tool.

### BACKGROUND OF THE INVENTION

In today's financial markets, the use of financial instruments known as “derivatives” have exponentially grown and is now common place. A derivative is an investment vehicle with a value that is based on the value of another security or underlying asset. That is, a derivative is essentially a financial instrument that is derived from the future movement of something that cannot be predicted with certainty. By the late 1990's the Office of the Comptroller of the Currency estimates that commercial banks in the United States alone, held over twenty trillion dollars worth of derivative-based assets. Common examples of derivatives include futures contracts, forward contracts, options, and swaps.

The relationship between the value of a derivative and the underlying asset are not linear and can be very complex. Economists have developed pricing models in order to valuate certain types of derivatives. At the core of various derivative pricing models are assumptions about how the price of the underlying asset (like a stock) may change over time. These pricing models provide probability distributions that describe the possible states of prices at different points in the future. Prices are generally modeled as a stochastic process, in which the values change over time in an uncertain manner. A particular type of stochastic process is the Markov process, where only the present state of the process (e.g., the current stock price) is relevant for predicting the future. The past history of the process is irrelevant.

A particular type of Markov process typically used to model prices is geometric Brownian motion (GBM). GBM, which is the basis of the vast majority of derivative pricing models, makes two key assumptions:

1. Price changes over small time intervals are independent, and therefore longer-term forecasts can be generated by repeatedly simulating small incremental changes in prices.

2. The distribution of future predicted prices is log-normal.

While there are many variations on the GBM approach to modeling asset or commodity prices, they all are fundamentally constrained by the two assumptions listed above. Consequently, while these approaches to modeling price may fit well in efficient, exchange-traded markets, they do not fit well in markets for commodities that are not traded on exchanges. Such markets are typically dominated by a handful of big buyers and big suppliers who negotiate prices directly. These markets tend to move not in a random fashion, as the “small independent intervals” assumption would suggest, but rather in cycles lasting from 6 months to several years. Within each cycle, periodically negotiated contract prices continue on a rising or falling trend, without deviation, until the market suddenly “turns” and prices head in the other direction. Therefore, the assumption that price changes over different horizons can all be modeled using the same model of changes over small, independent intervals is not good.

Accordingly, what is needed is a method and system that overcomes the constraints of the conventional methodology. The method and system should be simple, cost effective and capable of being easily adapted to existing technology. The present invention addresses these needs.

### SUMMARY OF THE INVENTION

The present invention includes a method and system for creating a price forecasting tool. Accordingly, a first aspect of the present invention is a method of creating a price forecasting tool. The method includes receiving historical data related to a commodity, defining a long-run average price trend based on the received historical data and creating a price forecasting tool based on the long-run average price trend wherein the price forecasting tool is capable of taking into account a market momentum of the commodity in order to generate a plurality of scenario prices of the commodity for a plurality of forecast horizons.

A second aspect of the present invention is a price forecasting system. The price forecasting system includes a user interface and a price forecasting tool coupled to the user interface wherein the price forecasting tool is created based on a long-term average price trend of the commodity and is capable of taking into account a market momentum of the commodity in order to generate a plurality of scenario prices of the commodity for a plurality of forecast horizons.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method in accordance with an embodiment of the present invention.

FIG. 2 is an illustration of a price forecasting system in accordance with an embodiment of the present invention.

FIG. 3 shows an example of a computer system that could be utilized in conjunction with an embodiment of the present invention.

FIG. 4 shows a posterior probability table and an adjusted R² table in accordance with an embodiment of the present invention.

FIG. 5 shows a long-term data history for DRAM prices in accordance with an embodiment of the present invention.

FIG. 6 shows an example of DRAM data assembled in a table format for performing regression analysis in accordance with an embodiment of the present invention.

FIG. 7 shows the results of the performance of regression analysis on the (t+4) horizon in accordance with an embodiment of the present invention.

FIG. 8 shows an example of a central sheet that contains all of the forecast coefficients of the forecast horizons in accordance with an embodiment of the present invention.

FIG. 9 is a flow chart of a method in accordance with an embodiment of the present invention.

FIG. 10 is an example of a graphical user interface that could be utilized in conjunction with a price forecasting tool in accordance with an embodiment of the present invention.

FIG. 11 is a detailed illustration of a short term forecast horizon graph in accordance with an embodiment of the present invention.

FIG. 12 shows an example of a detailed scenario output in accordance with an embodiment of the present invention.

### DETAILED DESCRIPTION

The present invention relates to a method and system for creating a price forecasting tool. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, the invention is a method and system for creating a price forecasting tool. By utilizing the method and system in accordance with the present invention, a separate statistical model is developed for each forecast horizon, rather than developing a single period model that is then run through simulations to develop longer term forecast distributions. Consequently, the method and system in accordance with the present invention is particularly well suited to commodities that show both strong momentum in the short-term (rising or falling price trends persist until a sudden market turn) and reversion to a trend line in the long-term (long-run average price follows a predictable declining trend based on rate of cost reduction from incremental technological progress). This is especially true with regard to manufactured goods, as opposed to raw materials.

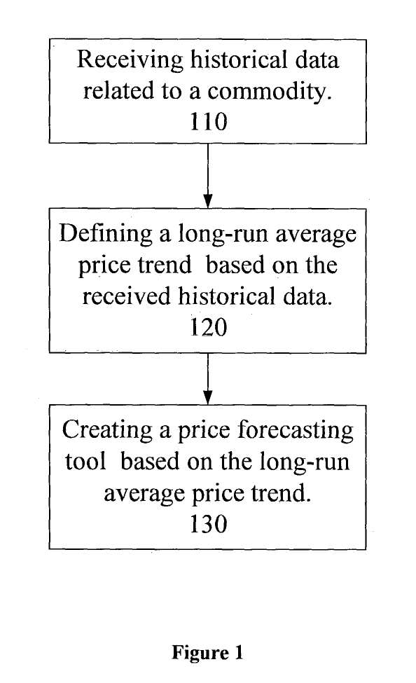

For a better understanding of the present invention please refer to FIG. 1. FIG. 1 is a high-level flow chart of a method in accordance with an embodiment of the present invention. First, historical data related to a commodity is received, via step 110. Next, a long-run average price trend is defined based on the received historical data, via step 120. A price forecasting tool is then created based on the long-run average price trend, via step 130. In an embodiment, the price forecasting tool is utilized to generate a plurality of scenario prices for the commodity for a plurality of forecast horizons while into account a short-term market momentum of the commodity. Additionally, the tool is capable of tailoring mean-reversion and price variance components of the long-run average price trend to each of the plurality of forecast horizons. This allows the tool to account for observations about market cycle amplitudes and frequencies.

Market Momentum

As previously stated, commodity markets that are not supported by traded futures or exchanges, exhibit substantially different behavior than “efficient” markets. In these markets (e.g. computer memory or flat panel displays), prices are dominated by a handful of big buyers and big suppliers, and the lead times for capacity expansion is long. In these markets, prices tend to move in cycles lasting from 6 months to 2 years. Consequently, markets that are not supported by exchanges and futures markets, particularly markets where the supply base has long lead times for expansion, will exhibit the “market momentum” aspect that is captured by the price forecasting tool in accordance with an embodiment of the present invention.

Flexibility to Tailor the Strength of the Mean Reversion to Each Forecast Horizon

Some commodity price models, like those typically applied to model electricity or oil prices, have a “mean-reversion” component, in which a long-run trend is defined and the stochastic process is a function of the difference between current price and trend price. However, since the stochastic process model only models one period forward, it assumes a single mathematical relationship between a forecast horizon and the strength of mean reversion. In accordance with an embodiment of the present invention, a separate statistical model is built for each horizon to relax the assumption about the strength of the mean reversion component. This enables a more accurate modeling of the momentum effects described above, while simultaneously capturing long-term mean reversion effects consistent with the cyclicality observed in the price history data.

Flexibility to Tailor Price Variance to Each Forecast Horizon

Typical stochastic process models use a single parameter to estimate one period price volatility. This results in the variance in the price forecast being a linear function of the time horizon. In creating the price forecasting tool in accordance with an embodiment of the present invention, this constraint is relaxed, since a separate model is developed for each forecast horizon. This added flexibility allows the tool to accurately capture the variance due to uncertainty about market turning points as well as uncertainty about the state of the price relative to the long-run trend. Without this flexibility, it would be difficult to model uncertainty about market turning points without imposing rigid assumptions.

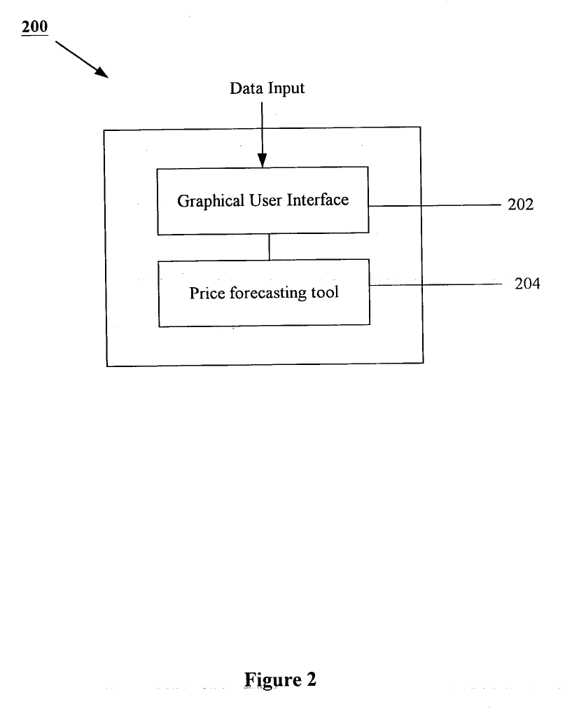

Please refer now to FIG. 2. FIG. 2 is an illustration of a price forecasting system 200 in accordance with an embodiment of the present invention. Price forecasting system 200 includes a graphical user interface 202 and a price forecasting tool 204. The graphical user interface 202 provides a convenient and efficient way for a user to enter data into the system 200. The price forecasting tool 204 then utilizes stored price modeling formulas to operate upon data received from the user in order to generate a plurality of scenario prices of the commodity for a plurality of forecast horizons, while taken into account the market momentum of the commodity. Additionally, the price forecasting tool 204 has the added flexibility to tailor the strength of the mean reversion and price variances components for each of the plurality of forecast horizons.

A user interface includes a combination of menus, screen design, keyboard commands, command language and online help, which creates the way a user interacts with a computer. Although the above disclosed embodiment of the present invention is described as being utilized in conjunction with a graphical user interface, one of ordinary skill in the art will readily recognize that any of a variety of user interfaces could be implemented while remaining within the spirit and scope of the present invention.

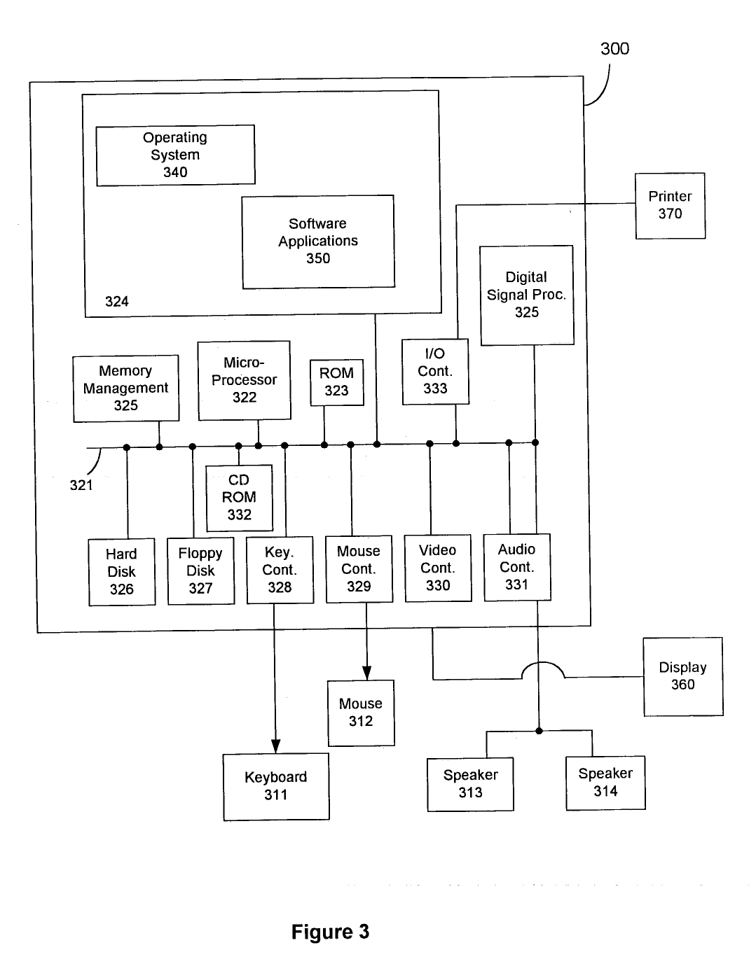

Price modeling system 200 may be implemented as one or more respective software modules operating on a computer system. For an example of such a computer system, please refer to FIG. 3. In FIG. 3, a computer system 300, including, a keyboard 311, a mouse 312 and a printer 370 are depicted in block diagram form. The system 300 includes a system bus or plurality of system buses 321 to which various components are coupled and by which communication between the various components is accomplished. The microprocessor 322 is connected to the system bus 321 and is supported by read only memory (ROM) 323 and random access memory (RAM) 324 also connected to the system bus 321. A microprocessor is one of the Intel family of microprocessors including the 386, 486 or Pentium microprocessors. However, other microprocessors including, but not limited to, Motorola's family of microprocessors such as the 68000, 68020 or the 68030 microprocessors and various Reduced Instruction Set Computer (RISC) microprocessors such as the PowerPC chip manufactured by IBM. Other RISC chips made by Hewlett Packard, Sun, Motorola and others may be used in the specific computer.

The ROM 323 contains, among other code, the Basic Input-Output system (BIOS) which controls basic hardware operations such as the interaction of the processor and the disk drives and the keyboard. The RAM 324 is the main memory into which the operating system 340 and software applications 350 are loaded. The memory management chip 325 is connected to the system bus 321 and controls direct memory access operations including, passing data between the RAM 324 and hard disk drive 326 and floppy disk drive 327. The CD ROM 332 also coupled to the system bus 321 is used to store a large amount of data, e.g., a multimedia program or presentation.

Also connected to this system bus 321 are various I/O controllers: the keyboard controller 328, the mouse controller 329, the video controller 330, and the audio controller 331. As might be expected, the keyboard controller 328 provides the hardware interface for the keyboard 311, the mouse controller 329 provides the hardware interface for mouse 312, the video controller 330 is the hardware interface for the display 360, and the audio controller 331 is the hardware interface for the speakers 313, 314. Another I/O controller 333 enables communication with the printer 370.

One of ordinary skill in the art will readily recognize that the computer system 300 could comprise a personal-digital-assistant (PDA), a mobile phone, a laptop computer or a variety of other devices while remaining within the spirit and scope of the present invention.

The system 300 may also be utilized in conjunction with a distributed computing environment where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet. Additionally, the networks could communicate via wireless means or any of a variety of 15, communication means while remaining within the spirit and scope of the present invention.

The above-described embodiment of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform the method in accordance with an embodiment of the present invention.

This computer readable media may comprise, for example, RAM contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (for example, a conventional “hard drive” or a RAID array), magnetic tape, electronic read-only memory, an optical storage device (for example, CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

Prices are typically modeled on a log-scale instead of on the natural (price) scale. This is done for two reasons. First, empirical evidence indicates that price changes are far more stable and symmetric when expressed as percent changes than when expressed in currency units. Second, this allows the capability to work with distributions of particularly convenient form, such as the Normal distribution.

In an embodiment of the present invention, the price forecasting tool is created from two structural components. The first component addresses the tendency of the market price to revert to a long-run equilibrium price, and is known generically as a “partial adjustment” model. This can be thought of as reflecting basic competitive forces that act to drive the market towards equilibrium regardless of the current market state, such as, if prices are very high, there will be a strong incentive on the part of suppliers to seize market share by reducing them (or not increasing them by as much as otherwise), or, if prices are very low, the firms' profit margins are low or negative, so there will be a strong incentive to increase them.

The second piece captures the short-term momentum of prices that underlies price swings. This reflects the market's short-term forecasting and planning processes that dominate price movements over the period of a few weeks or months. The two components together seem to capture many of the characteristics of the price process. The two components, along with other exemplary pricing models, are described separately below for greater clarity. Additionally, further characteristics of these components, as well as other statistical considerations, are available in detail in Bowman et al., “A Procedure for Modeling Future DRAM Prices using Historical Price Data”, Mar. 22, 2002, which is incorporated herein by reference in its entirety.

Steady State Model

The steady state model for the current log price, yₜ, is defined as:

yₜ=μₜ+eₜ (1)

where μₜ is the long-run equilibrium price and eₜ˜(0,σ²) according to some as-yet unspecified distribution. The subscript t refers to the time period of the observation, e.g., November 2001. This model is what is implemented when forecasting so far into the future that essentially no information is available other than the long-run equilibrium price curve about what the price might actually be.

The long-run equilibrium can be subtracted from both sides to get the canonical steady state equation:

zₜ=eₜ (2)

The subtraction is equivalent to dividing the actual price by the equilibrium price, then taking logs. Equation (2) is the form of the steady state equation used in an embodiment of the price forecasting tool in accordance with the present invention.

Partial Adjustment Models

Two forms of partial adjustment models will now be described. The first is one in which the equilibrium is constant over time and the second is one in which the equilibrium represents a moving target.

Constant Equilibrium

The basic partial adjustment model comes about through the following mechanism. The underlying assumption is that there is some optimal or equilibrium log price, μ*, that the actors in the marketplace would settle on eventually if there were no external influences or change. This corresponds to the steady state price described above. The current log price yₜ is some distance away from the equilibrium price. Each period the market price adjusts part of the way towards the equilibrium. The reasons for partial, instead of full, adjustment typically include ignorance of the true system parameters, inertia (e.g., contracts), and the costs of change.

A partial adjustment function can accordingly be constructed as follows:

yₜ−yₜ₋₁=γ(μ*−yₜ₋₁)+μₜ (3)

μₜ captures the randomness associated with the process. Note that, since a log scale is being utilized, equation (3) indicates movement of a constant geometric fraction of the distance towards the equilibrium, rather than a constant percentage fraction towards the equilibrium.

Rewriting this in terms of deviations from the equilibrium, as in equation (2), yields:

zₜ=δₜ₋₁+uₜ 0≦δ≦1 (4)

where δ=1−γ.

When considering multiple time horizons, the effect of the horizon on the adjustment parameter needs to be taken into account whereby the longer the market has to adjust, the more complete the adjustment will be. This leads to the following expression:

zₜ₊ₖ=δₖzₜ+uₜ₊ₖ 0≦δₖ≦1 (5)

Note that δₖ changes depending upon the horizon k. A complete adjustment over k periods implies that δₖ=0, but over shorter horizons, δ may well be greater than 0.

In many cases the assumption is that δₖ=δ^{k}₁. This relationship arises when, for example, planning the adjustment over several periods does not reduce adjustment costs relative to planning the adjustment one period at a time and there are no long-run elasticities in the sector of the economy that is being examined. This may not apply to the DRAM market. For example, the two-plus year lead-time to construct a wafer fab means that the three-year responsiveness of prices to market conditions is qualitatively different than the one-month responsiveness of prices. Even a few months can make a difference. A supplier can slow down or speed up the completion of a fab that is due to be finished in four months, for example, but over a one month horizon perhaps price changes are the only adjustment mechanism that is really available to a supplier. This implies, for example, that the DRAM future four months ahead is not likely to be equal to the “product” of four consecutive “one month ahead” futures.

Dynamic Equilibrium

In this case, the equilibrium log-price changes from period to period. As a result, two cases should be considered. Consider first what happens if the current log-price is right at the equilibrium. Assume that the equilibrium changes next period, but also assume the market knows in advance what it will be, at least to a fairly good degree of accuracy. Can the market adjust the actual price to keep up with changes in the equilibrium price? Or, alternatively, is the market always one or two steps behind, attempting to catch up with the moving target?

With respect to DRAM, a quick review of the price history of the DRAM marketplace indicates that the market has no trouble keeping up with the long run equilibrium price, herein defined by the long-run 32% year decline in prices, and formal testing confirms this. As it so happens, this conclusion simplifies the resultant model somewhat. Consequently, only the first case needs to be discussed, where the market can easily keep up with the changing equilibrium prices.

The general form of the adaptation model in this case is:

yₜ₊ₖyₜ=y*ₜ₊ₖ−y*ₜ+γ(y*ₜ−yₜ)+uₜ₊ₖ (6)

The first term on the right hand side, y*_{t+k,}, reflects the “easy” adjustment that the market makes on an ongoing basis, and the second term reflects the adaptive adjustment. In models where the equilibrium log-price changes at a constant rate (y*ₜ₊ₖ−y*ₜ=ck for some c independent of k), the adaptation equation can be written as:

yₜ₊ₖ−yₜ=ck+γ(y*ₜ−yₜ)+uₜ₊ₖ (7)

if the adjustment of the market to the change in the equilibrium is “easy”. Rewriting equation (6) in deviation form gives the same equation as the constant equilibrium price model:

zₜ₊ₖ=δₖzₜ+uₜ₊ₖ (8)

Thus, when working with the convenient deviation form, there is no need to distinguish between constant equilibrium prices and dynamic equilibrium prices that change at rates below the “noise level” of the system. This is the adaptation model utilized in the price forecasting tool in accordance with an embodiment of the present invention.

Short-term Price Trend Models

The next sequence of models to be considered are of increasing complexity and describe those short-term price movements not due to the partial adjustment process. The models build upon each other in a natural manner. The descriptions all assume that the one-period-ahead log-prices yₜ₊₁ are being modeled, but the extension to the more general yₜ₊ₖ will be clear.

Starting out with a basic price evolution process:

yₜ₊₁=yₜ+Tₜ+eₜ (9)

where Tₜ is the current trend. yₜ, the current log-price, is known, so in order to forecast a model of the one-period trend is needed. All of the differences between the following models relate to the structure of the trend Tₜ.

Constant Trend Model

One of the simplest models available is the constant trend model.

yₜ₊₁=yₜ+αᵤI(yₜ−yₜ₋₁>0)+α_{d}I+(yₜ−yₜ₋₁≦0)+eₜ (10)

$$I ( {y}_{t} - {y}_{t - 1} > 0 ) \{ = \begin{matrix}1 & {y}_{t} - {y}_{t - 1} > 0 \\ 0 & {y}_{t} - {y}_{t - 1} \leq 0\end{matrix}$$

αᵤ is the mean rate of change when prices have been trending up, and α_{d} is the mean rate of change when prices have been trending down. This model assumes there is one rate of change in prices when prices are trending up (relative to the partial adjustment term described above) and another rate of change when prices are trending down. The coefficients will have the probability of a change in the sign of the trend factored into them during the estimating procedure.

This model can be written in its more common form by using a constant term:

yₜ₊₁=yₜ+αᵤ+(α_{d}−αᵤ)I(yₜ−yₜ₋₁≦0)+eₜ (11)

Damped Trend Model

The second model extends the first by allowing trends to have changing rates:

yₜ₊₁=yₜ+α(yₜ−yₜ₋₁)+eₜ (12)

In this model, if prices have been increasing rapidly, the prices are expected to continue increasing more rapidly than if they have been increasing slowly. When α<1, the usual case, it is sometimes known as a “damped” trend model because the expected trend is getting less from one period to the next. In the statistical literature it is referred to as an ARIMA(1,1,0) model.

ARIMA stands for Autoregressive Integrated Moving Average. The structure (1,1,0) refers to the number of lagged left hand side variables on the right hand side, the degree of differencing (e.g., yₜ₊₁−yₜ is a 1st order difference), and the number of lagged error terms on the right hand side. The equation can be rewritten as:

zₜ=αzₜ₋₁+eₜ (13)

where the zₜ is the first difference of the yₜ, which makes the structure clearer.

Dynamic Trend Model

The next extension looks at how the trend is changing-thereby adding “trend of the trend” information to the previous model:

yₜ₊₁=yₜ+α(yₜ−yₜ₋₁)+β[(yₜ−yₜ₋₁)−(yₜ₋₁−yₜ₋₂)]+eₜ (14)

Here, information about whether the trend is accelerating ((yₜ−yₜ₋₁)>(yₜ₋₁−yₜ₋₂)) or decelerating ((yₜ−yₜ₋₁)<(yₜ₋₁−yₜ₋₂)) is incorporated in the estimate of the current trend. Generally, this model will have 0<α, β<1.

The dynamic trend model can be rewritten as:

yₜ₊₁yₜ=(α+β)(yₜ−yₜ₋₁)−β(yₜ₋₁−Yₜ₋₂)+eₜ (15)

This form is known in statistical literature as an ARIMA(2,1,0) model.

All of these models have asymmetric forms as well (note that the constant trend model presented above is already in its asymmetric form.) However, the analysis did not support the hypothesis that significant asymmetry is present in the DRAM marketplace in any of these models. Consequently, no such asymmetries are incorporated in the model.

The dynamic trend model can also be interpreted as a time-varying trend model. In this interpretation, the current trend, Tₜ₊1, changes from period to period according to:

Tₜ₊₁=Tₜ+θ₁Tₜ+θ₂Tₜ₋₁ (16)

θ₁=α+β−1

θ₂=−β

The Joint Model

This model combines the partial adjustment model of equation expressed in deviation form, with the dynamic trend model of equation:

zₜ=δzₜ₋₁+α(zₜ₋₁−δzₜ₋₂)β[(zₜ₋₁δzₜ₋₂)−(zₜ₋₂−δzₜ₋₃)]+eₜ (17)

The first term represents the partial adjustment to the long-run equilibrium, and its coefficient δ will typically approach 0 as the forecast horizon becomes large. The second term represents the trend, adjusted for the partial adjustment term, while the third captures the change in the trend from one period to the next, also adjusted for the partial adjustment terms. The corresponding coefficients will also typically approach 0 as the forecast horizon becomes large.

This expression generalizes to different time horizons as follows:

zₜ₊ₖ₋₁=δₖ zₜ₋₁+αₖ(zₜ₋₁−δ₁zₜ₋₂)+βₖ[(zₜ₋₁−δ₁zₜ₋₂)−(zₜ₋₂δzₜ₋₃)]+eₜ₊ₖ₋₁ (18)

As in the partial adjustment model above, the values of the coefficients will change over the horizon. Note, though, that the coefficients δ₁ are tied to the one-period ahead forecast, not the k-period ahead forecast, and consequently do not change over the forecast horizon.

The joint model can be rewritten as:

zₜ=(α+β+δ)zₜ₋₁+(β−δ(α+β))zₜ₋₂+βδzₜ₋₃+eₜ (19)

This form is known in statistical literature as an ARIMA (3,1,0) model. Upon observation, since β=0 for the damped trend model, the joint partial adjustment-damped trend model will be an ARIMA (2,1,0) model.

Model Selection

Model selection depends upon the time horizon that is being modeled. At different horizons, different models may be superior. For example, for a long time horizon, it is expected that the steady state model is the best, but for a short horizon such as one month, another model would probably be more accurate. Therefore, models should be selected based on the time horizon in question rather than assuming that one model fits all horizons adequately. The models considered are steady state, partial adjustment only, partial adjustment-damped trend and partial adjustment-dynamic trend.

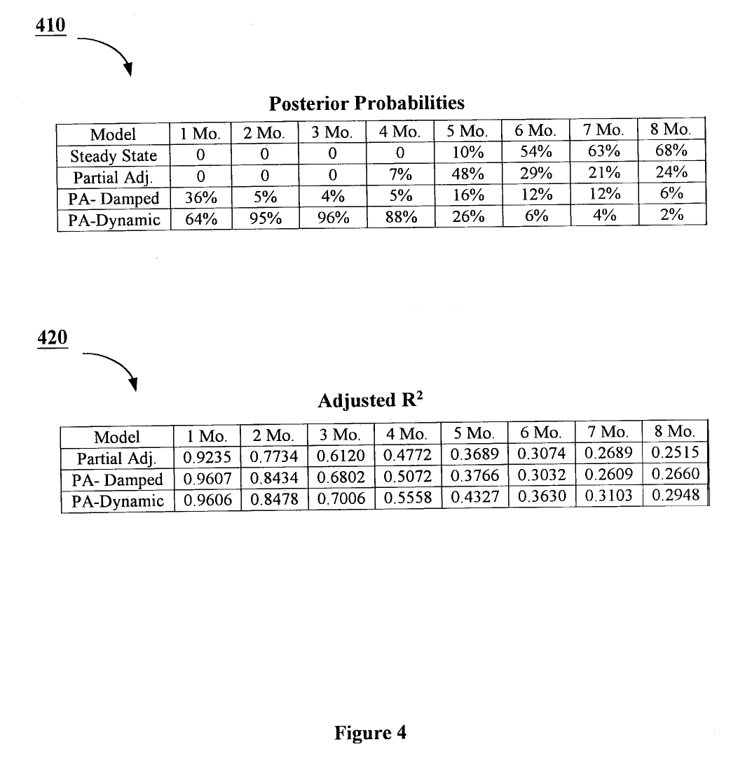

The evaluation is done on the basis of the posterior probability of the model. The posterior probabilities for forecast horizons of one to eight months are accordingly shown in table 410 of FIG. 4. Also shown in FIG. 4 is a table of the adjusted R² values 420 of the various models at the different horizons wherein the adjusted R² value roughly represents the percent of variance that can be predicted using the model. No R² statistic is included for the steady state model as it is equivalent to the “no model” and therefore has an R² value of 0. It should be noted that the partial adjustment-constant trend was dropped since it never had a posterior probability of 5% or more.

The inability to distinguish between the damped and dynamic trend model at the one-month horizon is due to the fact that in situations with low partial adjustment rates and trends that persist, the two models converge. For a one-period horizon, the amount of partial adjustment is not as substantial as it is over a two-period horizon, and the trend persists more over a one-period horizon than over a two-period horizon. The slight increase in the probability of the damped trend model at the longer horizons is because for small values of the trend parameter it becomes hard to distinguish it from the partial adjustment only model. As can be seen, for models of 1-4 month forecasts (short-term), the partial adjustment-dynamic trend model (which takes into account short term market momentum effects) explains significantly more of the data variance than the partial adjustment model (which does not take into account short term market momentum effects). Consequently, the price forecasting tool in accordance with an embodiment of the present invention, implements a partial adjustment-dynamic trend model to forecast the first few forecast horizons in order to take into account the effects of short term market momentum.

Testing Process Model Accuracy

Testing the adequacy of a process model is the same as testing to see whether the parameters of a multi-period horizon model are appropriate functions of the parameters of the single period horizon model. The equations for testing the dynamic trend model are more easily expressed using time series notation. Accordingly, the joint partial adjustment-dynamic trend model is reproduced as an ARIMA (3,1,0) process:

zₜ=φ₁zₜ₋₁+φ₂zₜ₋₂+φ₃zₜ₋₃+eₜ (20)

φ₁=α+⊖δ₁

φ₂=β−δ₁(α+β)

φ₃=βδ₁

If the expression is written for zₜ₊₁, the right hand side of equation 20 is substituted for the term zₜ and the two-period ahead expression can be expressed as:

zₜ₊₁=((φ₁)²+φ₂)zₜ₋₁+(φ₁φ₂+φ₃)zₜ₋₂+φ₂φ₃zₜ₋₃+eₜ (21)

Continuing this format yields corresponding expressions for zₜ₊₂, zₜ₊₃, etc.

The testing methodology is basically to estimate the terms of equation (21) and test to determine if the terms are the appropriate functions of the parameters of equation (20). The testing is done over horizons of two to four periods (as opposed to the conventional one period ahead forecast). The posterior probabilities of the partial adjustment-dynamic trend model for two months, three months and four months are 99%, 58% and 4% respectively. Hence, the process model is reasonable for two or three months out, but quickly deteriorates in quality.

These results support the hypothesis that the DRAM marketplace frequently takes actions to stabilize the market that do not mature for several months, such as delaying or advancing the completion date of new wafer manufacturing lines, etc. These results also demonstrate that utilizing separate models for each forecast horizon, as is the case with the price forecasting tool in accordance with an embodiment of the present invention, is superior to utilizing a single process model (e.g. a Markov process) that assumes that price changes over small intervals are independent.

### PROCESS OVERVIEW

In general, the process for creating the price forecasting tool in accordance with an embodiment of the present invention includes three stages:

(1) Defining a price model, and the long-run trend;

(2) Performing regression analysis; and

(3) Building the price forecasting tool.

Defining the model

In order to use a long history of data and give the model a long lifetime, the model should be carefully defined so as to isolate the influence of uncertain market factors from predictable technological trends. For example, if 128 MB DRAM prices are to be modeled, then this data history would be dominated by the life cycle trends from 128 MB DRAM. When the product is introduced, prices start high, then drop quickly through the life cycle. However, this would not provide a clear picture of the uncertain market influences on DRAM prices. If the price of mainstream DRAM (lowest price/Mb part at any given time) is specifically what is of interest, a better approach would be to collect a data history of price/Mb on whichever parts had the lowest price/Mb at the time. If trailing edge prices are of interest, then data should be collected on the lowest absolute part price over time. In either case, a generic and broadly applicable definition of what is being modeled should be implemented.

Although the above-described embodiment is disclosed as being utilized to in conjunction with computer memory (e.g. DRAM), one of ordinary skill in the art will readily recognize that a variety of commodities could be utilized in conjunction with the price forecasting tool while remaining within the spirit and scope of the present invention.

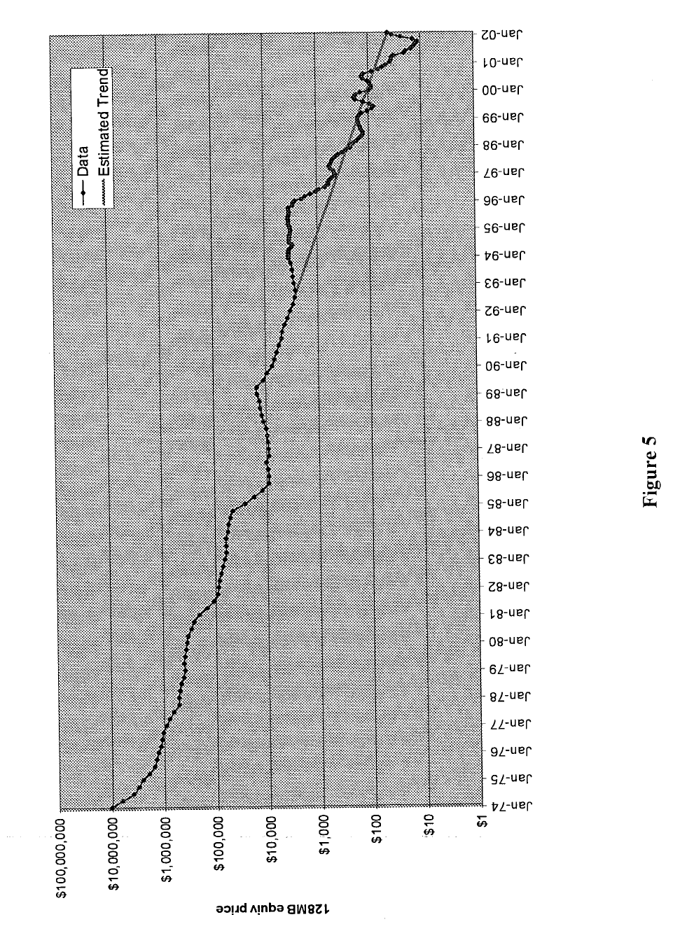

Next, as much data as possible is collected about the commodity, along with market intelligence about current prices and costs, to calibrate a long-run average price trend line relevant to the recent price history. A key analysis in building the tool, which is both quantitative and subjective, involves setting the long-run trend line. For example, FIG. 5 shows a long-term data history for DRAM prices, stated in terms of $/128 MB, and collected from prices reflecting the mainstream (lowest $/128 MB) density at each point in time. When the price history is plotted on a log-scale, a constant rate of price decline appears on the graph as a straight line.

The objective here is to decide the slope and height of that line. The data can be a starting point (fitting a best fit line to the log of the price data series), but industry reports (e.g., Dataquest) and market intelligence should also be used to the extent possible. For example, there may be market intelligence regarding the anticipated future rate of price decline (as driven by cost decline assumptions). Also, there may be market intelligence that helps to identify value of the trend line at various points in time (helping calibrate the height of the line). For example, in DRAM, it was known that prices were roughly at variable cost in Q4'01. It was also known from an analysis of Micron financial reports and an analysis of a proposed Infineon fab investment that DRAM suppliers needed prices to be about 3.5×cost on average to be profitable. Assuming that suppliers need to be marginally profitable in the long-term to stay in business, one data point for the Q4'01 value of the long-run trend could be obtained.

Although the entire data series is probably helpful in calibrating a long-term trend, it may be the case that only a recent portion of the data reflects current market dynamics. For example, in FIG. 5 it is observed that DRAM price cycles have become much more frequent and pronounced in the last 5-10 years. Accordingly, the data from '96-'02 could be utilized to create the price forecasting tool.

Additionally, a data set should be chosen that is consistent with the estimated long-run trend line. For example, the '93-'95 data set could be excluded since the cycle was much longer than recent cycles and since prices were very high relative to the estimated trend line. Finally, if market momentum effects are to be taken into account, it is essential that at least a few market cycles are observed in the selected data set.

Performing Regression Analysis

A regression equation expresses the relationship between two (or more) variables algebraically. It indicates the nature of the relationship between two (or more) variables. In particular, it indicates the extent to which some variables can be predicted by knowing others, or the extent to which some are associated with others.

In order to conveniently perform regression analysis, the data is transformed into a form that is consistent with the linear regression model. For example:

z(t)=LN[price(t)/trend price(t)]=LN[(price(t)]−LN[trend price(t)] (22)

is a convenient form to account for mean-reversion effects and the assumption that the price distribution follows a log-normal distribution.

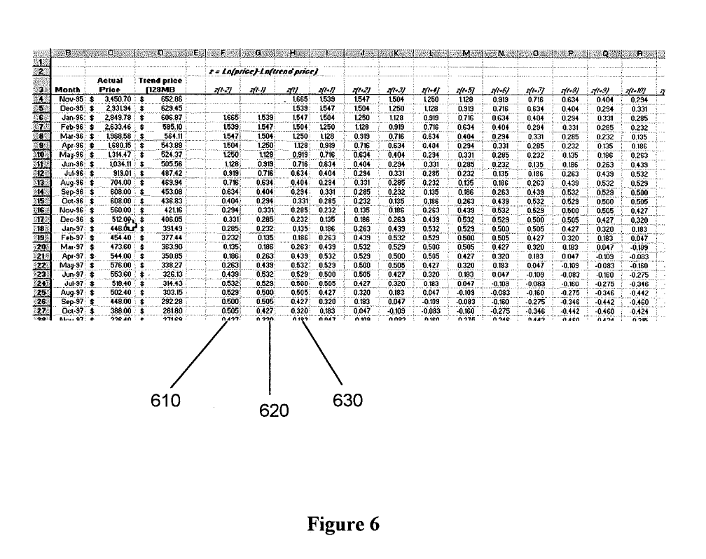

The gathered data should then be assembled in a table format. FIG. 6 shows an example of DRAM data assembled in a table format for performing regression analysis. The first three columns 610, 620, 630 respectively, are z(t-2), z(t-1), and z(t), where t is the time in months forward or backward from a data point. These columns are the predictor variables. Each other column is the predicted variable and is used to generate a separate regression model for the forecast at that horizon. The data only needs to extend as far out as the longest horizon to be modeled using the market momentum [z(t−2), z(t−1)] or mean-reversion [(z(t)] predictor variables. (Longer “steady-state” horizons can also be modeled without the predictor variables by just using the “constant” column as the predictor variable.)

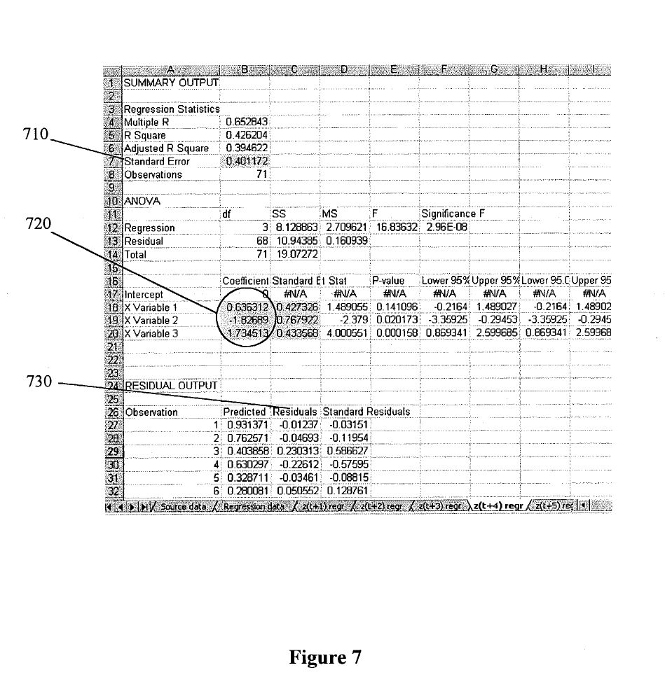

Regression analysis is then performed on each forecast horizon in order to determine the forecast coefficients for that particular horizon. In an embodiment, the regression analysis can be performed with the “Tools/Data Analysis” menu in a Microsoft Excel® program. A separate sheet should be generated for each horizon. For example, FIG. 7 shows the results of the performance of regression analysis on the (t+4) horizon. The parameters of interest are the standard error of regression 710, forecast coefficients 720 and residuals 730. These will be incorporated into a master sheet that contains the calculated forecast coefficients of each forecast horizon.

The standard error of regression 710 should be reviewed at this point to decide which predictor variables should be kept in the model. Based on model selection, all of the predictor variables may not need to be included in models of longer-term forecasts. For example, in the DRAM case, (t+1) through (t+6) are built utilizing the dynamic-partial adjustment models. For the t+12 horizon, only the partial adjustment model is utilized and for longer horizons (e.g. t+24), the z(t) column 630 (see FIG. 6) is regressed on the “constant” column to estimate a steady-state standard error.

As a rule of thumb, if the standard error is larger than the coefficient itself, then the coefficient is not statistically significant. In that case, the regression should be run again without that predictor variable. In general, either all three predictors will be used (dynamic partial adjustment model), only the z(t) predictor will be used (partial adjustment model), or no predictors will used (steady-state model)

Building the Price Forecasting Tool

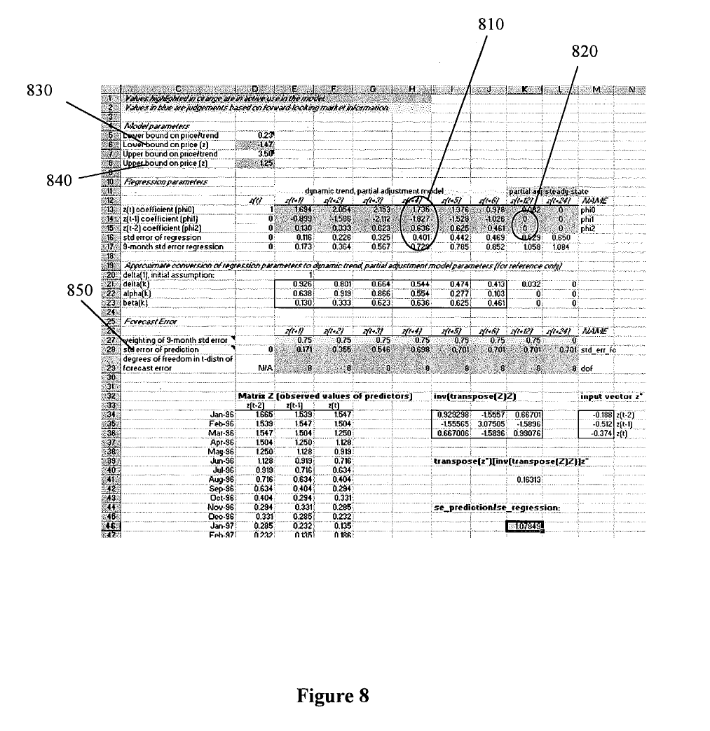

Once regression analysis is performed on each of the forecast horizons, the estimated forecast coefficients from each regression sheet should be linked to a central sheet. FIG. 8 shows an example of a central sheet 800 that contains all of the forecast coefficients of the forecast horizons. For example, forecast coefficients 720 shown in FIG. 7, are shown in FIG. 8 at column H, (rows 13-15) 810. If a “reduced” model is used (not all three predictor variables were used in the regression), then zero values should be put in for the coefficients on the variables not used [e.g., (K14 and K15) 820].

The coefficients should then be interpreted to see if the coefficients make sense. Rows 21-23 in FIG. 8 are approximations to the parameters delta, alpha, and beta. If delta is much less than 1, the mean (trend) reversion is strong [Eqn. (5) above]. If alpha is much greater than 0, then the “velocity” component of the market momentum is strong [Eqn. (12) above]. If beta is much greater than 0, then the “acceleration” component of the market momentum is strong [Eqn. (14) above]. If these parameters do not change smoothly as the forecast horizon increases, then dropping predictor variables from some of the horizons and re-running the regression should be considered.

If necessary, the standard error of prediction 850 can be adjusted to reflect more recent market conditions. For example, in the DRAM example, volatility during '01-'02 was about twice as high as volatility during the '96-'02 period used to estimate the coefficients. The volatility from the last 9 months is therefore estimated by calculating the square root of the average of the square of the residuals 730 (see FIG. 7).

Additionally, there may be some hard constraints on the forecasts that need to be imposed externally. For example, referring to FIG. 8, a lower bound 830 and an upper bound 840 could be defined for the forecast distribution. For example, a lower bound (relative to the long-run trend) may relate to the variable cost of production. Prices would not fall significantly below variables costs, even for a short period. An upper bound may relate to such factors as elasticity of market demand, availability of substitute products, or ability to bring on line new capacity or production. The best indicator of an upper bound is observation of the highest previously observed price/trend ratio, with some additional margin added.

In an embodiment of the present invention, the finalized central sheet containing all of the final forecast coefficient could be stored in a centralized database and utilized as the price forecasting tool to generate future scenario prices for an associated commodity. In an embodiment, four user inputs are implemented to generate the scenario prices. These inputs include the current month (to calibrate long-run trend), the current commodity price, the price one month ago, and the price two months ago. Once the data is entered via the graphical user interface 202 (FIG. 2), the price forecasting tool 204 is then utilized to generate an output in graphical form, based on the user inputs wherein the output includes a display of a plurality of scenario prices of the commodity for a plurality of forecast horizons whereby each scenario price has an associated percentile. The percentile represent a probability that a future price of the commodity will be lower than the associated scenario price.

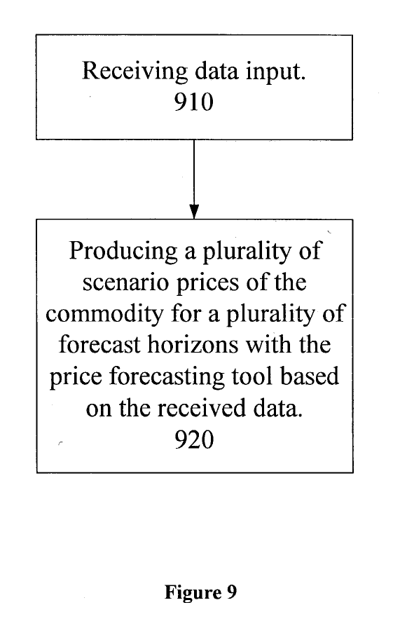

For a better understanding, please refer now to FIG. 9. FIG. 9 is a flow chart of a method in accordance with an embodiment of the present invention. First, data input is received, via step 910. In this embodiment, the data includes the current month, the current commodity price, the price one month ago, and the price two months ago. Next, a plurality of scenario prices of the commodity for a plurality of forecast horizons is produced by the price forecasting tool based on the received input, via step 920. Additionally, the price forecasting tool generates an associated percentile for each of the plurality of scenario prices wherein the percentile represent a probability that a future price of the commodity will be lower than the associated scenario price.

In order to generate the output, the current and projected value of the long-run trend is calculated. Using assumptions about the annual percent decline in price (slope of the log-price graph), the long-run trend is projected out over each horizon. This requires the user to input “current month”, so that the price forecasting tool can determine the current value of the trend and project forward. This trend is used to translate prices to “z” values (log price/log trend).

The standard error of prediction can then be calculated. It is calculated based on a multiplier (>1) of the standard error of regression. The multiplier is a matrix calculation of the 3×1 input “z” vector, z*, and the n×3 matrix of observed z values (sample data), Z. This multiplier just “inflates” the standard error by a small factor, based on how different the current z values are from those in the sample data. Therefore, forecasts generated when prices are unusually high (z>1) or low (z<1) will have higher forecast error than those generated when prices are near the long-run trend (z˜1).

The percentiles of the forecast distribution are then calculated using the coefficients of the central sheet (FIG. 8) and the inputs for the current values of z(t), z(t−1), and z(t−2). For example, the “predicted” (50^{th} percentile) value of z(t+k) is calculated. Then, an “error” is applied to that prediction by multiplying the standard error of prediction by the value of the t-distribution at that percentile. The upper and lower bound constraints on z are then applied, so that the distribution is truncated at these bounds. Finally, the percentile for z (log price/log trend) is converted back into a price by exponentiating and multiplying by the current value of the long-run trend.

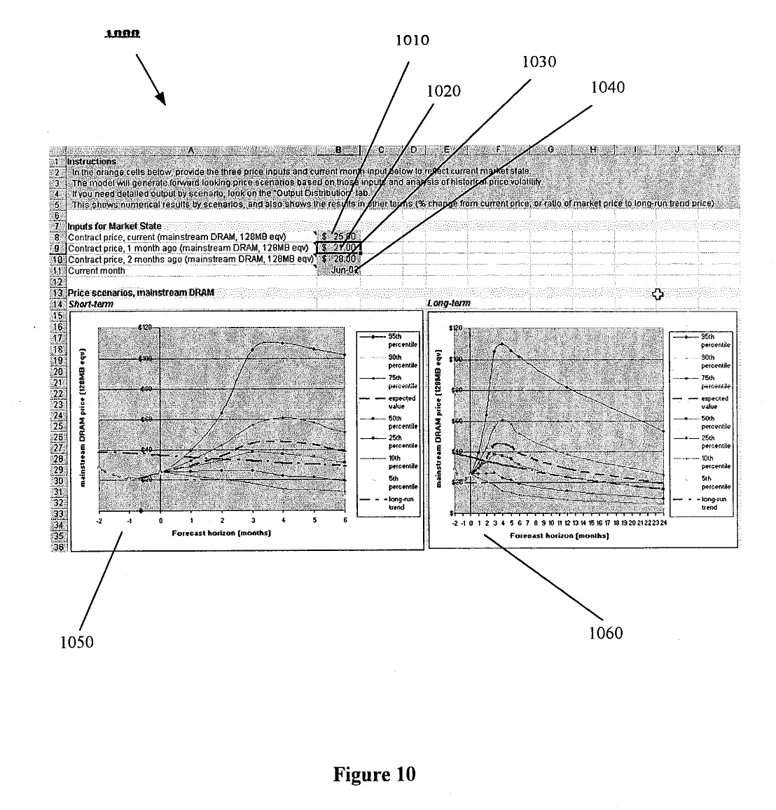

Please refer now to FIG. 10. FIG. 10 is an example of a graphical user interface 1000 that could be utilized in conjunction with a price forecasting tool in accordance with an embodiment of the present invention. The interface 1000 includes a “current price” input area 1010, a “price one-month ago” input area 1020, a “price two-months ago” input area 1030, and a “current month” input area 1040. The graphical user interface 1000 also includes a short-term forecast horizon graph 1050 and a long-term forecast horizon graph 1060.

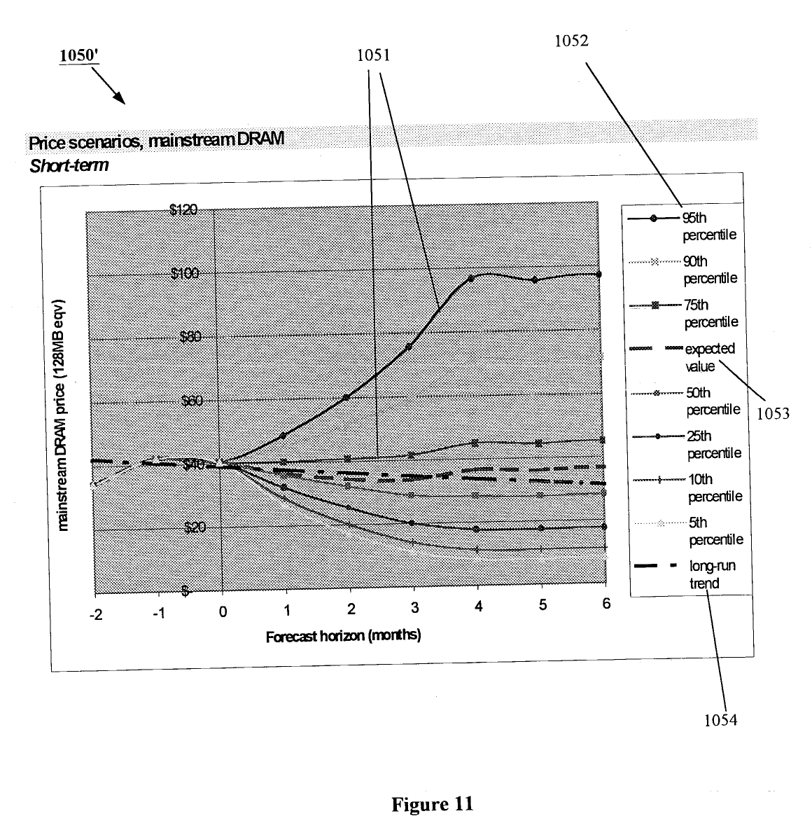

For a more detailed understanding of the graphs, please refer now to FIG. 11. FIG. 11 is a detailed illustration of a short-term forecast horizon graph 1050′ in accordance with an embodiment of the present invention. The graph 1050′ includes scenario prices 1051 wherein each scenario price has an associated percentile 1052. In an embodiment, each percentile has a corresponding line color whereby the line representing the associated scenario price is the line color of the corresponding percentile. For example, if the 95^{th} percentile has a green line color, than the line representing the scenario price associated with the 95th percentile is green. The graph 1050′ also includes an expected value 1053 and a long trend value 1054. It should be understood that a long-term forecast horizon graph could include elements similar to those outlined in the short-term forecast horizon graph 1051′.

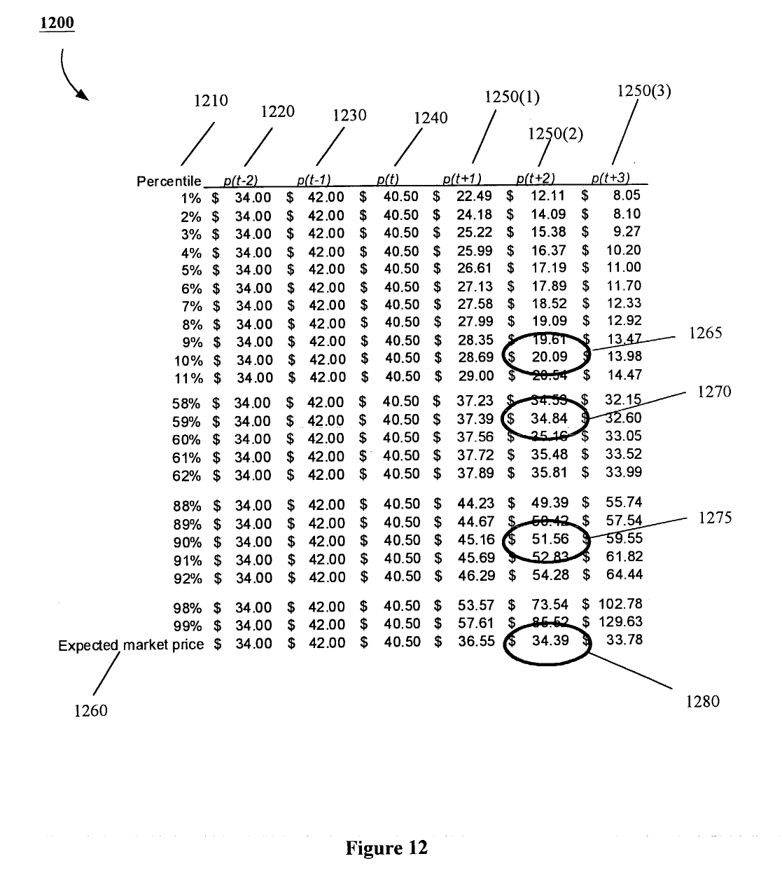

Both the short-term forecast horizon graph 1050 and the long term forecast horizon graph 1060 can be utilized to evaluate potential deals involving commodity price commitments. However, a detailed scenario output could be utilized to accomplish this as well. FIG. 12 shows an example of a detailed scenario output 1200 in accordance with an embodiment of the present invention. The detailed scenario output 1200 is presented in a table format and includes associated percentiles 1210, the price two-months ago 1220, the price one-month ago 1230, the current price 1240, monthly forecast horizon prices 1250(1), 1250(2), 1250(3). 1250(n) (where n is the monthly horizon beyond the current month) and the expected market price 1260. Accordingly, the detailed scenario output 1200 can be easily analyzed to evaluate the value of potential deals involving price commitments.

For example, if today's price is $39, and a supplier offers a forward price 2 months in advance at $35, is this a good deal? It sounds good, but an analysis of the detailed scenario output 1200 reveals that it is barely a break-even deal. The “expected price two months from now” 1280 is $34.39, so on average the opportunity cost is $0.61 per 128 MB unit. The chance that the market price will be less than $35 is at the 59^{th} percentile 1270, so there is a lot of downside risk. For example, in a “low scenario” (10^{th} percentile 1265), price could drop to $20.09, and the opportunity cost would be $35−$20.09=$14.91/unit. Conversely, in a “high scenario” (90^{th} percentile 1275), price could increase to $51.86, and the savings would be $51.56−$35=$16.56.

Again, although the above-described embodiments are disclosed as being utilized in conjunction with computer memory (e.g. DRAM), one of ordinary skill in the art will readily recognize that a variety of commodities (e.g. flat panel display monitors, etc.) could be utilized while remaining within the spirit and scope of the present invention. Additionally, the above-described forecast horizons, although disclosed as being “monthly” could be any desired time frame (weekly, yearly, etc.).

A method and system for creating a price forecasting tool is disclosed. By utilizing the method and system in accordance with the present invention, a separate statistical model is developed for each forecast horizon, rather than developing a single period model that is the run through simulations to develop longer term forecast distributions. Consequently, the method and system in accordance with the present invention is particularly well suited to commodities that show both strong momentum in the short-term and reversion to a trend line in the long-term.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed:

1. A method of creating a price forecasting tool comprising:
receiving historical data related to a commodity;
defining a long-run average price trend based on the received historical data; and
creating a price forecasting tool based on the long-run average price trend wherein the price forecasting tool is capable of taking into account a market momentum of the commodity in order to generate a plurality of scenario prices of the commodity for a plurality of forecast horizons.

2. The method of claim 1 wherein the price forecasting tool is capable of tailoring a mean-reversion component of the long-run average price trend to each of the plurality of forecast horizons.

3. The method of claim 1 wherein the price forecasting tool is capable of tailoring a price variance component of the long-run average price trend to each of the plurality of forecast horizons.

4. The method of claim 1 wherein the commodity comprises manufactured goods.

5. The method of claim 1 wherein creating the price forecasting tool further comprises:
utilizing a linear regression technique on the historical data to estimate at least one forecasting coefficient for each of the plurality of forecast horizons.

6. The method of claim 5 wherein the price forecasting tool is further capable of utilizing the at least one forecasting coefficient to generate the plurality of scenario prices for each of the plurality of forecast horizons.

7. The method of claim 1 further comprising:
allowing the price forecasting tool to receive data input; and
producing the plurality of scenario prices based on the data input.

8. The method of claim 7 wherein the data input comprises a current month, a current price of the commodity, a price of the commodity approximately 1 month prior to the current month and a price of the commodity approximately 2 months prior to the current month.

9. The method of claim 7 wherein a scenario percentile is associated with each of the plurality of scenario prices and producing the plurality of scenario prices further comprises:
displaying the scenario percentile of each of the plurality of scenario prices wherein the scenario percentile is a probability that an future price of the commodity will be lower than the associated scenario price.

10. The method of claim 9 wherein the commodity comprises dynamic random access memory.

11. A computer program product for creating a price forecasting tool, the computer program product comprising: a computer usable medium having computer readable program means for causing a computer to perform the steps:
receiving historical data related to a commodity;
defining a long-run average price trend based on the received historical data;
creating a price forecasting tool based on the long-run average price trend wherein the price forecasting tool is capable of taking into account a market momentum of the commodity in order to generate a plurality of scenario prices of the commodity for a plurality of forecast horizons.

12. The computer program product of claim 11 wherein creating a price forecasting tool further comprises:
utilizing a linear regression technique on the historical data to estimate at least one forecasting coefficient for each of the plurality of forecast horizons.

13. The computer program product of claim 12 wherein the price forecasting tool is further capable of utilizing the at least one forecasting coefficient to generate the plurality of scenario prices for each of the plurality of forecast horizons.

14. The computer program product of claim 11 further comprising the steps of:
allowing the price forecasting tool to receive data input; and
producing the plurality of scenario prices based on the data input.

15. The computer program product of claim 14 wherein the data input comprises a current month, a current price of the commodity, a price of the commodity approximately 1 month prior to the current month and a price of the commodity approximately 2 months prior to the current month.

16. A price forecasting system comprising:
a user interface; and
a price forecasting tool coupled to the user interface wherein the price forecasting tool is created based on a long-term average price trend of a commodity and is capable of taking into account a market moment of the commodity in order to generate a plurality of scenario prices of the commodity for a plurality of forecast horizons.

17. The price forecasting system of claim 16 wherein the long-term average price trend of the commodity is defined based on historical data related to the commodity.

18. The price forecasting system of claim 16 wherein the price forecasting tool is capable of tailoring a mean-reversion component of the long-run average price trend to each of the plurality of forecast horizons.

19. The price forecasting system of claim 16 wherein the price forecasting tool is capable of tailoring a price variance component of the long-run average price trend to each of the plurality of forecast horizons.

20. The price forecasting system of claim 16 wherein the user interface further comprises:
means for allowing the price forecasting tool to receive data input; and
means for producing the plurality of scenario prices based on the data input.

21. The price forecasting system of claim 20 wherein the data input comprises a current month, a current price of the commodity, a price of the commodity approximately 1 month prior to the current month and a price of the commodity approximately 2 months prior to the current month.

22. A method of doing business comprising:
creating a price forecasting tool based on a long run average price trend of a commodity; and
utilizing the price forecasting tool to generate a plurality of scenario prices for a commodity for a plurality of forecast horizons wherein the price forecasting tool takes into account a market momentum of the commodity.

23. The method of claim 22 wherein the long-term average price trend of the commodity is defined based on historical data related to the commodity.

24. The method of claim 22 wherein the price forecasting tool is capable of tailoring a mean-reversion component of the long-run average price trend to each of the plurality of forecast horizons.

25. The method of claim 22 wherein the price forecasting tool is capable of tailoring a price variance component of the long-run average price trend to each of the plurality of forecast horizons.
